(19) United States
(12) Patent Application Publication
(10) Pub. No.: US 2026/0032394 A1
(43) Pub. Date: Jan. 29, 2026

(54) ASSEMBLY METHOD FOR A HEARING DEVICE AND HEARING DEVICE

(71) Applicant: Sivantos Pte. Ltd., Singapore (SG)

(72) Inventors: Yew Kwan Andrew TOH, Singapore (SG); Muhammad Shahid BIN SHITH, Singapore (SG); Sushanta Kumar SAHU, Singapore (SG)

(21) Appl. No.: 19/279,078

(22) Filed: Jul. 24, 2025

(30) Foreign Application Priority Data
Jul. 24, 2024 (EP) 24190676.7

(51) Int. Cl. H04R 25/00

(52) U.S. Cl. CPC H04R 25/609; H04R 25/602; H04R 25/65; H04R 2225/021; H04R 2225/57

(57) ABSTRACT

An assembly method for a hearing device includes an elongated circuit board center section and two circuit board side parts. Positioning devices are installed on both circuit board side parts. Afterwards, the circuit board side parts are connected, mechanically and for signal transmission, to the circuit board center section to form a circuit board arrangement. The circuit board side parts are aligned in an orientation transverse to a surface of the circuit board center section by the respective positioning devices. The circuit board arrangement is then housed by at least two housing shells.

### CROSS-REFERENCE TO RELATED APPLICATION

This application claims the priority, under 35 U.S.C. § 119, of European Patent Application EP 24 190 676.7, filed Jul. 24, 2024; the prior application is herewith incorporated by reference in its entirety.

### FIELD AND BACKGROUND OF THE INVENTION

Hearing devices are regularly used to output a sound signal to the hearing of the wearer of the hearing device. The output is generated by an output transducer, usually acoustically via airborne sound by a loudspeaker (also referred to as a “receiver”). Such hearing devices are often used as so-called hearing aids. For that purpose, hearing devices usually include an acoustic input transducer (in particular a microphone) and a signal processor which is set up to process the input signal (also: microphone signal) generated by the input transducer from the ambient sound. Such sound processing is done by applying at least one signal processing algorithm, usually stored in a user-specific manner, in such a way that a hearing loss of the wearer of the hearing device is at least partially compensated. In particular in the case of a hearing aid, the output transducer may be, alternatively to a loudspeaker, a so-called bone-conduction earphone or a cochlear implant, which are set up for mechanical or electrical coupling of the sound signal into the hearing of the wearer. The term hearing devices additionally includes, in particular, devices such as so-called tinnitus maskers, headsets, headphones and the like.

Typical configurations of hearing devices, in particular hearing aids, are behind-the-ear (“BTE”) and in-the-ear (“ITE”) hearing devices. Those configurations refer to the intended wearing position. In-the-ear hearing aids have a (main) housing that is worn behind the auricle. A distinction can be made between models having a loudspeaker which is located in the housing—the sound is usually emitted to the ear by using a sound tube that is worn in the ear canal—and models that have an external loudspeaker that is placed in the ear canal. In-the-ear hearing aids, on the other hand, have a housing that is worn in the pinna or even completely in the ear canal.

Hearing devices include housings encapsulating main parts of the electrical components such as the signal processor, microphone, battery and the like. Usually, at least some of those electrical components are mounted to a circuit board which is then fixed to a so-called frame. The frame ensures a three-dimensional positioning of the components within the housing. Due to miniaturization of the hearing devices, the alignment of the circuit board, the frame and, if applicable, other components of the hearing devices within the restricted space of the hearing device's housing is a time-consuming labor. Fitting the circuit board onto—or often also into openings of—the frame gives a hindrance to automated assembly of the hearing device.

### SUMMARY OF THE INVENTION

It is accordingly an object of the invention to provide an assembly method for a hearing device and a hearing device, which overcome the hereinafore-mentioned disadvantages of the heretofore-known methods and devices of this general type and which enable automated assembly of a hearing device.

With the foregoing and other objects in view there is provided, in accordance with the invention, an assembly method intended and serving for assembling a hearing device, preferably a hearing aid. According to the assembly method (or in short: “the method”) an elongated circuit board center section and two circuit board side parts are provided. Positioning devices are installed on both circuit board side parts. The circuit board side parts are connected, mechanically and for signal transmission, to the circuit board center section to form a circuit board arrangement. The circuit board side parts are aligned in an orientation transverse to a surface of the circuit board center section by the respective positioning devices, optionally after or before the connecting step. In particular, the positioning devices serve at least for finding the correct orientation with respect to the circuit board center section and/or to each other. Additionally, the printed circuit board arrangement is housed (i.e., encased or encapsulated) by at least two housing shells.

Further beneficial and probably inventive embodiments are described within the dependent claims as well as in the following specification.

Making use of the positioning devices makes it easier to repeatedly align the circuit board side parts in the correct position and orientation regarding the circuit board center section. “Repeatedly” is in that context understood as for assembling many hearing devices after one another (i.e. not in the sense of repeating the assembly step only with the same components for only hearing device). Reproducibility and/or repeat accuracy is fundamental for an automated assembly process. Thus, the invention enables the assembly to be performed at least with the help of automation. Additionally, due to the described “self-alignment” of the circuit side parts, a frame for holding the circuit board or several small circuit boards and/or components in place may be discarded. Preferably, according to a beneficial variant of the method, the method described here and in the following is carried out automatically by a robot.

According to a preferred variant of the method, during the alignment of the two circuit board side portions, the positioning devices are connected to each other for fixation of the circuit board side portions, especially in their respective orientations. Thus, the positioning devices serve not only for finding the correct (or intended) position of the circuit side parts but also for holding them in that position. Especially, the transverse orientation of the (circuit board) side parts with regard to the (circuit board center section) may cause some deviations from the intended orientation due to elastic restoring forces in case circuit boards are bent or due to assembly tolerances when soldered connection devices or the like are being used. The positioning devices, thus, enable the correct and lasting positioning of the side parts-which in turn is again beneficial for automated assembly processes.

According to a further variant of the method, a battery port (or: “battery holder”) is assembled (or installed) on one of the side parts or the center portion. That battery port is configured to and intended for mechanically holding and electrically contacting a battery-which in turn is intended to provide energy to the hearing device's electric components at least during intended operation of the hearing device. Into the battery port a battery is inserted, especially after alignment of the side parts and bevor enclosing the circuit board arrangement with the housing shells.

According to an expedient further development of the aforementioned variant, the battery port mounted on one of the side parts and a respective counterpart mounted on the other side part are used as the positioning devices—or at least as some of several such positioning devices. E.g., the battery port is a circularly shaped collar in combination with spring contacts wherein a knob (or button) cell battery type may be inserted, in which case the counterpart may also be a circular collar which, during alignment of the side parts, is put over the battery port. In that case, the battery port has the additional function of some kind of alignment pin.

According to an alternative or optionally additional variant of the method, a male and a female plug connector are used as (in the case of the battery port serving as the positioning devices, as possibly further) the positioning devices. The plug connectors are plug connected to each other during alignment of the side parts. Preferably, the plug connectors are latched in the plugged state such that the plug connectors may not be detached unintentionally from each other.

According to a preferred variant of the method, the positioning devices are attached to the respective associated circuit board side part by a surface-mount-technique (SMT). Especially, the positioning devices are soldered to the circuit board side parts the way in which surface-mount-devices (SMD) are soldered.

Preferably, the battery port is also attached, especially soldered, via SMT to the respective side part or center section.

According to an optional variant of the method, the step of mechanically and in terms of signal transmission connecting the side parts (to the center section) is carried out by soldering.

According to an alternative, preferred embodiment, the step of mechanically and in terms of signal transmission connecting the side parts (to the center section) is carried out by a board-to-board connector, in each case. In that case, preferably, to each of the center section and the respective side parts a respective connector part (e.g., a male or female connector part, respectively) is attached in a way that the underlying circuit boards, specifically the respective electrically conducting paths, are galvanically connected to that connector part. Afterwards, the connector parts are plugged into each other, by connecting the respective side part to the center section.

Such a board-to-board connector may be already configured to realize a transverse orientation of the side part. However, even in this case the positioning devices are beneficial to further the precision of the alignment.

According to a preferred variant of the method, as the elongated circuit board center section, a flex PCB (printed circuit board) is used. Such a flex PCB includes flexible folding lines, which can be plastically deformed by applying an assembly force value. Additionally, such a flex PCB also includes rigid (or stiff)—i.e. not plastically, possibly only elastically, deformable under the assembly force value—carrier sections, which are delimited from one another by the folding lines. Thus, the flex PCB may be bent or folded in certain areas (the folding lines) and stays flat in the other areas. In particular, the center section is bent in a roughly banana-shaped (also referred to as C-shaped) manner.

According to another preferred variant of the method, rigid printed circuit boards are used as the circuit board side parts. Preferably, those circuit board side parts are configured to, at least for some parts, close an area which is circumscribed by the C-shaped (folded) flex PCB.

Preferably, a parting plane of the housing shells is oriented approximately transverse to the circuit board side parts. The housing shells are clipped to at least one of the side parts or center section and/or to each other. Thus, for housing the circuit board arrangement, the assembled circuit board arrangement (especially with the side parts already aligned transverse to the center section) is inserted into one of both housing shells in a direction parallel to the side parts. Preferably, the circuit board arrangement is inserted into the top (or upper) shell and optionally clipped into it by respective locking devices (such as a snap hook or similar snap fitting devices) of that shell. The other shell is then, preferably, clipped to the top shell. Especially, the housing shells are manufactured separately, preferably injection molded, from a thermoplastic resin.

Optionally, at least one of the housing shells, especially the top shell, includes holding devices for holding a microphone, a button or the like.

With the objects of the invention in view, there is concomitantly provided a hearing device, which comprises an elongated circuit board center section, two circuit board side parts and positioning devices mounted on both circuit board side parts. The circuit board side parts are mechanically and in terms of signal-transmission connected to the circuit board center section to form a circuit board arrangement. Further, the circuit board side parts are aligned transversely to a surface of the circuit board center section by the respective positioning devices being connected to one another. Additionally, the circuit board arrangement is encased in at least two housing shells.

Preferably, the hearing device described above is assembled by the method described above. Thus, the claimed hearing device shares the same physical features as described in the course of description of the assembly. Also, the hearing device benefits from the same advantages as the method and vice versa.

The conjunction “and/or” is to be understood here and in the following in particular in such a way that the features linked by this conjunction can be realized both together and as alternatives to one another.

Other features which are considered as characteristic for the invention are set forth in the appended claims.

Although the invention is illustrated and described herein as embodied in an assembly method for a hearing device and a hearing device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, side-elevational view of a hearing device;

FIGS. 2 and 3 are bottom-plan views of two examples of a circuit board arrangement in an only partially assembled state;

FIG. 4 is a perspective view of the circuit board arrangement according to a second example;

FIG. 5 is a side-elevational view of positioning devices;

FIG. 6 is a perspective view of a battery holder; and

FIG. 7 is another bottom-plan view similar to FIG. 3, of the circuit board arrangement.

### DETAILED DESCRIPTION OF THE INVENTION

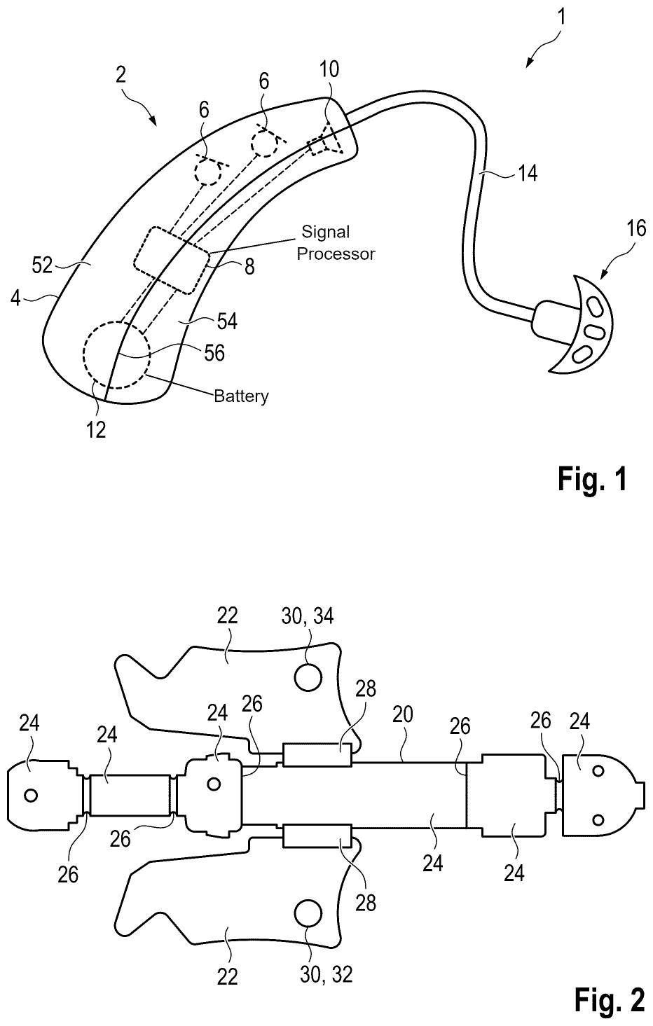

Referring now in detail to the figures of the drawings, in which corresponding parts are always provided with the same reference signs, and first, particularly, to FIG. 1 thereof, there is seen a diagrammatic view of a hearing device, in this case, in particular, a hearing aid 1 for hearing-impaired people. The hearing aid 1 is of a so called behind the ear (“BTE”) configuration which means that a main body 2 of the hearing aid 1 is worn behind the pinna of a user (i.e., the hearing-impaired person to whom the hearing aid 1 belongs). The hearing aid 1 includes a housing 4 which makes up for the outer shape of the main body 2. In the housing 4 electric and electronic components of the hearing aid 1 are accommodated, such as two microphones 6, a signal processor 8, a receiver 10 and a battery 12 (especially a secondary cell).

The microphones 6 are used to pick up environmental sounds and provide these as electric signals to the signal processor 8. The signal processor 8 performs signal processing such as sound analysis, noise detection, noise removal, applying (especially frequency dependent) gain to the signal and other processing known in the art. The resulting signal is an output signal which is adapted to the hearing impairment of the user and which is outputted acoustically by the receiver 10. In the presented example, the receiver 10 is placed in the housing 4 and the sound generated on the basis on the output signal is transmitted via a sound tube 14 to an ear piece 16 which is to be worn in the ear canal. Another embodiment of BTE hearing aids may have an external receiver which is connected to the housing 4 and the signal processor 8 via a cable and intended to be worn within the ear canal. A further embodiment may include as an alternative to an output transducer, a bone-conduction earphone or a cochlear implant.

In the following, a method for assembling the hearing aid 1, at least the main body 2, and respective embodiments of the hearing aid 1, is described which is intended to enable automated assembly, e.g., by a robot.

In a first step (FIG. 2) an elongated circuit board center section 20 is provided along with two circuit board side parts 22 (for short: “wings 22”). The center section 20 is a narrow (i.e. at a multiple longer than wide) strip of a flexible printed circuit board (“flex PCB”) which includes stiff areas 24 (also referred to as “carrier sections 24”) which are delimited towards each other by flexible folding lines 26. These folding lines 26 are used for bending (or folding) the center section 20 into a C-shaped or banana-shaped form (cf. FIG. 4). Within these folding lines 26, a plastic deformation (the bending) is caused by applying an assembly (or folding) force value. Within the carrier sections 24, applying that assembly force value would only cause elastic deformation. The components attached to the center section 20 are located within those carrier sections 24. The wings 22 are made of stiff PCB.

The center section 20 as well as the wings 22 carry (or are used to carry in a later step) electric and electronic components such as one or more chips that make up the signal processor 8, circuitry (chips and/or other semiconductor devices) that resemble a power management device for controlling electric energy from the battery 12 and during a charging state to the battery 12, the microphones 6, etc.

In a second step, a respective board-to-board connector 28 is used to connect the wings 22 mechanically as well as electronically to the center section 20. The board-to-board connectors 28 are attached by soldering or by cutting clamps (e.g. during a previous, not explicitly mentioned step) to the center section 20 and/or the wings 22, respectively. Optionally the board-to-board connector 28 includes complementary connector parts (attached to each PCB respectively) for plug connection between the respective PCBs.

In a third step, the wings 22 are brought to an orientation in which they are aligned transversely with regard to the center section 20 (cf. FIG. 4).

Depending on the kind of board-to-board connectors 28 used, the second step and the third step may also be interchanged in the course of assembly such that the aligned wings 22 are then connected by the respective board-to-board connectors 28 to the center section 20.

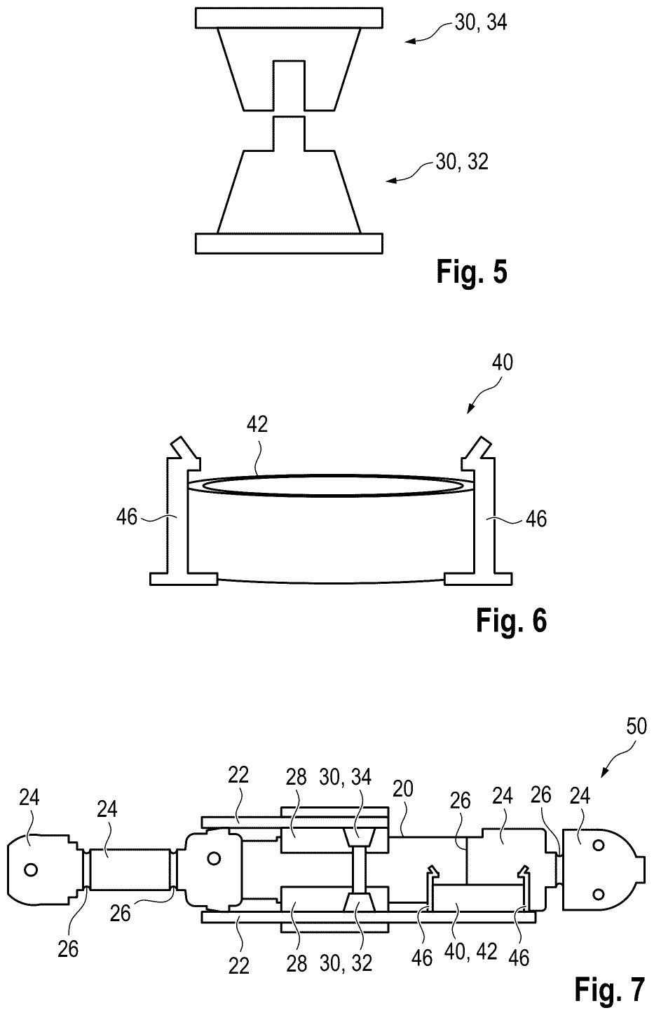

In order to ensure that the alignment of the wings 22 regarding the center section 20 stays the same during the following steps, positioning devices 30 are attached to both of the wings 22. In the embodiment described herein, these positioning devices 30 are in the form of a male plug connector 32 (for short: “plug pin 32”; cf. FIG. 5) and a female plug connector 34 (for short: “socket 34”). The positioning devices 30 are configured to easily find the intended alignment of the wings 22 and additionally, to lock the wings 22 in that alignment. Therefore, the positioning devices 30 include snap fit features that are not shown in detail. One possibility would be to configure the plug pin 32 and the socket 34 such that a friction force between them is high enough to hold both wings 22 in place. Another expedient example is to form a little knob (not shown) onto the distal end of the plug pin 32 and a corresponding groove into the socket 34 which would interlock with each other by elastic deformation during connecting. Such snap fit features are generally known to a skilled person. The positioning devices 30 are realized as surface mount devices (SMD) which are attached to the wings 22 by soldering onto the surface of the respective PCB.

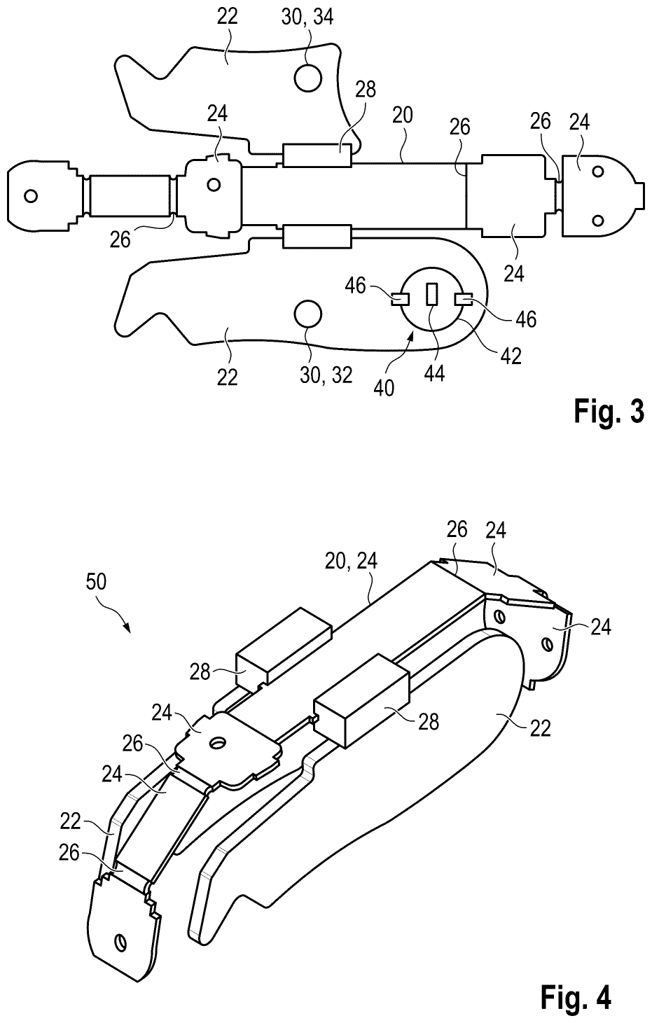

In FIG. 3 another embodiment of the wings 22 is shown. One wing 22 is longer than the other one and carries a battery holder 40 (also referred to as a “battery port”). The battery holder 40 is also a SMD and includes a collar 42 for receiving a button cell type battery as well as one contact spring 44 at the bottom and two other contact springs 46 for contacting the other side (pole) of the battery as well as for holding the battery in place within the collar 42. For that purpose, the contact springs 46 are configured as snap hooks.

The bending (folding) of the center section 20 may take place before the wings 22 are attached and/or aligned as shown in FIG. 4. Alternatively, the bending may also be done after attaching and aligning the wings 22.

The center section 20, the wings 22 attached thereto and aligned as shown in FIG. 4 (preferably, the center section 20 and the wings 22 already fitted with the respective electronic components) embody (or represent) a “circuit board arrangement 50”). Such a circuit board arrangement 50 is, within another step, inserted into the housing 4. For that purpose, the housing 4 includes a top shell 52 and a bottom shell 54 that part within a parting plane which intersects the housing 4 at a parting line 56 (cf. FIG. 1). The parting plane is transverse to the wings 22. The circuit board arrangement 50 is inserted into the upper shell 52 and, within its intended position, clipped into that upper shell 52. Preferably, the upper shell 52 includes for that purpose snap fit elements (not shown or described in greater detail) that interlock with the center section 20—or alternatively with the wings 22. Then, the bottom shell 54 is pushed over the circuit board arrangement 50 and clipped to the top shell 52.

In a step before, a battery is inserted into the battery holder 40 and snap fitted with the contact springs 46.

Due to the positioning devices 30 that are configured to find the intended positioning of the wings 22 in relation to the center section 20 and to lock the wings in that positioning, handling of the circuit board arrangement 50 is made easier. That enables use of robotic devices for assembling the circuit board arrangement 50. Especially, a so-called “frame,” usually a plastics component which is used as a carrier and alignment master for the PCBs used in conventional hearing aids, may be discarded. That, additionally, makes the course of assembly easier (especially less dependent on manual work).

The object of the invention is not limited to the embodiments described above. Rather, further embodiments of the invention can be derived by the person skilled in the art from the above description. In particular, the individual features of the invention and their variants described with reference to the various examples can also be combined with one another in other ways.

The following is a summary list of reference numerals and the corresponding structure used in the above description of the invention:
1 hearing aid
2 main body
4 housing
6 microphone
8 signal processor
10 receiver
12 battery
14 sound tube
16 ear piece
20 center section
22 wing
24 carrier sections
26 folding line
28 board-to-board connector
30 positioning devices
32 plug pin
34 socket
40 battery holder
42 collar
44 contact spring
46 contact spring
50 circuit board arrangement
52 top shell
54 bottom shell
56 parting line

1. An assembly method for a hearing device, the assembly method comprising:
providing an elongated circuit board center section having a surface;
providing two circuit board side parts;
installing positioning devices on the two circuit board side parts;
connecting, mechanically and for signal transmission, the circuit board side parts to the circuit board center section to form a circuit board arrangement;
using the respective positioning devices to align the circuit board side parts in an orientation transverse to the surface of the circuit board center section; and
using at least two housing shells to house the circuit board arrangement.

2. The assembly method according to claim 1, which further comprises, during the alignment of the two circuit board side parts, connecting the positioning devices to each other for fixation of the circuit board side parts.

3. The assembly method according to claim 1, which further comprises:
assembling a battery port for mechanically holding and electrically contacting a battery on one of the circuit board side parts or the circuit board center section; and
inserting a battery into the battery port.

4. The assembly method according to claim 3, which further comprises using, as the positioning devices, the battery port mounted on the one of the circuit board side parts and a counterpart mounted on another of the circuit board side parts.

5. The assembly method according to claim 1, which further comprises using a male and a female plug connector as the positioning devices, and plug-connecting the male and female plug connectors to each other during the alignment of the two circuit board side parts.

6. The assembly method according to claim 1, which further comprises using a surface-mount-technique to attach each of the positioning devices to a respective associated circuit board side part.

7. The assembly method according to claim 1, which further comprises carrying out the mechanical and signal transmission connecting of the circuit board side parts by soldering.

8. The assembly method according to claim 1, which further comprises carrying out the mechanical and signal transmission connecting of each of the circuit board side parts by using a respective board-to-board connector.

9. The assembly method according to claim 1, which further comprises using a flex PCB as the elongated circuit board center section, the flex PCB including rigid carrier sections delimited from one another by flexible folding lines configured to be plastically deformed by applying an assembly force value.

10. The assembly method according to claim 1, which further comprises using rigid printed circuit boards as the circuit board side parts.

11. The assembly method according to claim 1, which further comprises defining a parting plane of the housing shells oriented approximately transverse to the circuit board side parts, and clipping the housing shells (52, 54) to at least one of the circuit board side parts or to at least one of the center section or each other.

12. The assembly method according to claim 1, which further comprises carrying out the method automatically by using a robot.

13. A hearing device, comprising:
an elongated circuit board center section having a surface;
two circuit board side parts;
positioning devices mounted on said two circuit board side parts;
said circuit board side parts being mechanically and in terms of signal-transmission connected to said circuit board center section to form a circuit board arrangement;
said positioning devices being connected to one another for aligning said circuit board side parts transversely to said surface of said circuit board center section; and
at least two housing shells encasing said circuit board arrangement.
